(19) United States
(12) Patent Application Publication
(10) Pub. No.: US 2015/0274970 A1
(43) Pub. Date: Oct. 1, 2015

(54) CONTROL OF INTERNAL VISCOSITY IN IN SITU POLYMERIZED ORGANOPOLYSILOXANE EMULSIONS

(71) Applicant: Wacker Chemical Corporation, Adrian, MI (US)

(72) Inventor: Michael Larson, Ypsilanti, MI (US)

(73) Assignee: Wacker Chemical Corporation, Adrian, MI (US)

(21) Appl. No.: 14/225,514

(22) Filed: Mar. 26, 2014

(51) Int. Cl. C08L 83/04

(52) U.S. Cl. CPC C08L 83/04

(57) ABSTRACT

Aqueous emulsions of in situ-polymerized hydroxyl-functional organopolysiloxanes prepared in the presence of an acid catalyst and an alkanol have lower neat fluid viscosities than otherwise similar polymers prepared in the absence of the alkanol.

### BACKGROUND OF THE INVENTION

1. Field of the Invention

The invention pertains to in situ polymerized aqueous emulsions. More particularly, the invention pertains to aqueous organopolysiloxane emulsions prepared by polymerizing hydroxyl-terminated organopolysiloxanes in an aqueous medium.

2. Description of the Related Art

Aqueous emulsions of organopolysiloxanes have many uses in both industrial processes and consumer-directed fields such as cosmetics and hair care products.

One method of preparing organopolysiloxane emulsions involves polymerization from an emulsion of lower molecular weight starting materials. For example, in U.S. Pat. No. 2,891,920, organopolysiloxane emulsions are prepared by ring opening polymerization of octamethylcyclotetrasiloxane (“D4”), in aqueous dispersion, and in the presence of strong acids or bases as a catalyst. In DE 1495512, sulfonic acids and their salts are used as catalysts for aqueous emulsion polymerization of cyclic siloxanes. In these processes as well as others which polymerize cyclic siloxanes, sometimes with additional reactants as well, for example JP2006-117868, a problem which occurs is that the products contain a considerable content of cyclic siloxanes, at times above 10 weight percent. These cyclic siloxanes are of low viscosity, and hence lower the overall viscosity of the oil phase. Moreover, cyclic siloxanes having a low number of siloxy groups are volatile and thus may present environmental or toxicological concerns.

Organopolysiloxane emulsions may be prepared by polymerization of hydroxyl-terminated organopolysiloxanes, but the products generally do not have the desired shear and storage stability. In particular, the viscosity may increase over time due to further condensation of silanol hydroxyl groups. Moreover, in the acid catalyzed polymerization, the acid catalyst must be neutralized precisely and rapidly at the time the target viscosity is reached, which presents certain technical difficulties, particularly when large batches are being prepared.

It would be desirable to produce organopolysiloxane emulsions in situ by a process which is more flexible, and which prepares products with good viscosity stability.

### SUMMARY OF THE INVENTION

These and other objects are achieved by an in situ process for polymerizing hydroxyl-functional organopolysiloxanes in aqueous medium, wherein an alkanol is added during the acid catalyzed polymerization.

### DETAILED DESCRIPTION OF THE PREFERRED EMBODIMENTS

The hydroxyl-functional organopolyxiloanes useful in the emulsion polymerization of the invention include at least two silicon-bonded hydroxyl groups. Thus, the preferred hydroxyl-functional organopolysiloxanes are α,ω-bis(hydroxyl)organopolysiloxanes. Such organopolysiloxanes are readily commercially available in a wide range of molecular weights, and correspond generally to the formula

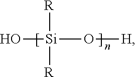

where R denotes a substituted or unsubstituted hydrocarbon radical having 1 to 40 carbon atoms, more preferably 1 to 20 carbon atoms, yet more preferably 1 to 18 carbon atoms, and most preferably 1 to 8 carbon atoms. The hydrocarbon radical may be aliphatic, cycloaliphatic, aryl, arylaliphatic, or alkaryl in nature, and when there are two or more carbon atoms, may be interrupted by non-adjacent oxygen atoms. R is preferably methyl, ethyl, n-propyl, i-propyl, n-butyl, phenyl, or benzyl, in particular methyl or phenyl, and more particularly methyl. Substituents are preferably halo, particularly chloro, or cyano, or aminoalkyl. The value of n is from 2 to 10⁵, more preferably 2 to 1000, and most preferably such that the viscosity, measured at 25° C., is from 5 to 80,000 mm²/s. A suitable hydroxyl-functional organopolysiloxane is PDM-Siloxan, a 60 mm²/s hydroxyl-terminated polydimethylsiloxane available from Wacker Chemie AG, Munich, Germany.

It is also possible to employ hydroxyl-functional organopolysiloxanes where all or part of the hydroxyl groups are pendant to the organopolysiloxane chain, as well as organopolysiloxanes bearing three or more silicon-bonded hydroxyl groups. However, this is not preferred due to the possibility of considerable crosslinking which may raise the product viscosity to unacceptably high levels, or create solids. It is preferable that the products of the invention which constitute the oil phase of the aqueous emulsions be liquid at 25° C. It is possible, however, to use tri-or higher hydroxyl functionality organopolysiloxanes especially if monohydroxyl functional organopolysiloxanes are also included. Mixtures of mono, di-, and/or higher hydroxyl-functional organopolysiloxanes are also contemplated.

The alkanols which are useful are preferably hydrocarbon monols having the formula R¹-OH where the hydroxyl group is bonded to carbon, and R¹ is a hydrocarbon radical having from 1 to 40 carbon atoms, more preferably 1 to 18 carbon atoms, and most preferably 1-4 carbon atoms. Examples include methanol, ethanol, i-propanol, n-propanol, i-butanol, n-butanol, and t-butanol. R¹ may also be cycloaliphatic, for example cyclopentanol, cyclohexanol, dimethylcyclohexanol, or may be arylaliphatic, such as benzyl alcohol. It is preferred that R¹ not be phenolic, for example phenol or naphthol. When R¹ is cycloaliphatic, R¹ should contain 5 or more carbon atoms, and when arylaliphatic, should contain 7 or more carbon atoms. R¹ may be substituted or unsubstituted. Examples of suitable substituents include halo, cyano, keto, and ester groups. R¹ may also contain interspersed oxygen atoms, for example methoxyethanol.

The alkanol is preferably used in amounts of 0.01 to 10 weight percent based on the weight of the hydroxyl-functional organopolysiloxane, more preferably 0.1 to 8 weight percent, and most preferably 0.2 to 5 weight percent. The alkanol must be present during the in situ polymerization, but need not be initially present, e.g., the alkanol may be added during the course of the polymerization.

Additional organopolysiloxanes may be present as well, including trialkylsilyl-capped organopolysiloxanes, preferably trimethylsilyl-capped organopolysiloxanes as disclosed in U.S. published application 2011/0269892. These may be of low molecular weight, e.g. hexamethyldisiloxane, or of higher molecular weight, e.g. oligomeric or polymeric. These organopolysiloxanes preferably have a viscosity of at least 20 mm²/s, more preferably 40 mm²/s, and most preferably ≧55 mm²/s, and correspond to the general formula

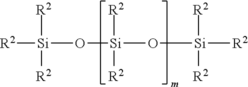

where R², individually, has the meaning of R, and is preferably C₁₋₁₈ alkyl, more preferably C₁₋₄ alkyl, yet more preferably methyl or phenyl, and most preferably methyl, and m is chosen such that the above viscosity ranges are met.

The polymerization may also include chlorosilanes (not preferred) or alkoxysilanes, preferably triorganoalkoxysilanes and organodialkoxysilanes, wherein the organo groups are preferably those corresponding to R. Most preferably, organotrialkoxysilanes and tetraalkoxysilanes are not used, since these may cause the formation of highly branched products unless the amounts used are quite low. The alkoxy groups may be C₁₋₁₈ alkoxy groups, preferably C₁₋₄ alkoxy groups, and most preferably methoxy or ethoxy groups. Preferably, no alkoxysilanes are copolymerized. When alkoxysilanes are used, the alcohol liberated by condensation reactions is not included in the alkanol content of the process.

The polymerization emulsion contains at least one surfactant to stabilize the emulsion during the polymerization process and in the product. Any suitable surfactant may be used. Suitable surfactants include the following:

Anionic emulsifiers such as:
1. Alkyl sulphates, particularly those having a chain length of 8 to 18 carbon atoms, alkyl and alkaryl ether sulphates having 8 to 18 carbon atoms in the hydrophobic moiety and 1 to 40 ethylene oxide (E0) or propylene oxide (PO) units.
2. Sulphonates, particularly alkylsulphonates having 8 to 18 carbon atoms, alkylarylsulphonates having 8 to 18 carbon atoms, taurides, esters and monoesters of sulphosuccinic acid with monohydric alcohols or alkyl-phenols having 4 to 15 carbon atoms; optionally, these alcohols or alkylphenols can also be ethoxylated with 1 to 40 EO units.
3. Alkali metal and ammonium salts of carboxylic acids having 8 to 20 carbon atoms in the alkyl, aryl, alkaryl or aralkyl moiety.
4. Phosphoric mono- and diesters and their alkali metal and ammonium salts, particularly alkyl and alkaryl phosphates having 8 to 20 carbon atoms in the organic moiety, alkyl ether and alkaryl ether phosphates having 8 to 20 carbon atoms in the alkyl or alkaryl moiety and 1 to 40 EO units.

Nonionic emulsifiers such as:
5. Polyvinyl alcohol with a degree of polymerization in the range from 500 to 3000 which still has 5 to 50%, preferably 8 to 20% vinyl acetate units.
6. Alkyl polyglycol ethers, preferably those having 3 to 40 EO units and alkyl radicals of 8 to 20 carbon atoms.
7. Alkylaryl polyglycol ethers, preferably those having 5 to 40 EO units and 8 to 20 carbon atoms in the alkyl and aryl radicals.
8. Ethylene oxide-propylene oxide (EO-PO) block copolymers, preferably those having 8 to 40 EO and/or PO units.
9. Addition products of alkylamines having alkyl radicals of 8 to 22 carbon atoms with ethylene oxide or propylene oxide.
10. Fatty acids having 6 to 24 carbon atoms.
11. Alkylpolyglycosides of the general formula R*—O—ZO, where R* denotes a linear or branched, saturated or unsaturated alkyl radical having on average 8-24 carbon atoms and ZO denotes an oligoglycoside radical having on average o=1-10 hexose or pentose units or mixtures thereof.
12. Natural substances and their derivatives, such as lecithin, lanolin, saponines, cellulose; cellulose alkyl ethers and carboxyalkylcelluloses, the alkyl groups of which each have up to 4 carbon atoms.
13. Linear organo(poly)siloxanes, in particular those having alkoxy groups with up to 24 carbon atoms and/or up to 40 EO and/or PO groups and containing polar groups containing more particularly the elements O, N, C, S, and P.

Cationic emulsifiers such as:
14. Salts of primary, secondary and tertiary fatty amines having 8 to 24 carbon atoms with acetic acid, sulphuric acid, hydrochloric acid or phosphoric acids.
15. Quaternary alkyl- and alkylbenzeneammonium salts, in particular those whose alkyl groups have 6 to 24 carbon atoms, more particularly the halides, sulphates, phosphates and acetates.
16. Alkylpyridinium, alkylimidazolinium and alkyloxazolinium salts, particularly those whose alkyl chain has up to 18 carbon atoms, specifically the halides, sulphates, phosphates and acetates.

Ampholytic emulsifiers such as:
17. Amino acids having long-chain substituents, such as N-alkyl di(aminoethyl)glycine or N-alkyl-2-amino-propionic acid salts.
18. Betaines, such as N-(3-acylamidopropyl)-N,N-dimethylammonium salts having a C₁₋₁₈ acyl radical, and alkylimidazolium betaines.

Preference for use as emulsifiers is given to nonionic emulsifiers, more particularly the alkyl polyglycol ethers recited above under 6. The emulsifier can consist of one of the abovementioned emulsifiers or of a mixture of two or more of the above-mentioned emulsifiers, in pure form or as solutions of one or more emulsifiers in water or organic solvents.

The process of the present invention preferably utilizes the emulsifiers in amounts of at least 0.1 part by weight, more preferably at least 0.4 part by weight and more particularly at least 0.8 part by weight and at most 80 parts by weight, more preferably at most 60 parts by weight and more particularly at most 30 parts by weight, per 100 parts of hydroxyl-functional organopolysiloxane.

In lieu of organic surfactants as described above, or in addition to them, partially water-wettable silicas which are hydrophoticized only to a limited extent, can be used as emulsifiers/dispersants. These can also be used in conjunction with the above-described surfactants. Examples of such partially water-wettable silicas are described in U.S. Pat. Nos. 7,541,405, 7,722,804, 8,333,946, and 8,374,033. Other partially water-wettable inorganic oxides such as aluminas, titanias, aluminum silicates, aluminum titaniates, etc., may also be used in like fashion. Such inorganic oxides must be available in finely divided form, for example as pyrogenic metal oxides or mixed metal oxides. In any case, the amount of total surfactants, including those described both above and below, should be sufficient to maintain the components in emulsion form, at least during polymerization, and preferably following polymerization. If necessary, additional surfactants may be added during polymerization or post-polymerization.

A polymerization catalyst is necessary. Hydroxyl-functional organopolysiloxanes are relatively stable in aqueous emulsion, in particular since the relatively large excess of water, if anything, tends to retard reaction. There are both acidic and basic catalysts which are suitable for condensation polymerization of organopolysiloxanes silanol groups. However, acidic catalysts generally provide for increased reaction rates and therefore reduced cycle times, which is of paramount importance. Thus, acidic catalysts are preferred.

Examples of acidic catalysts are Bronsted acids, such as hydrochloric acid, hydrobromic acid, sulphuric acid, chlorosulphonic acid, phosphoric acids, such as ortho-, meta- and polyphosphoric acids, boric acid, nitric acid, benzenesulphonic acid, p-toluenesulphonic acid, methanesulphonic acid, trifluoromethanesulphonic acid and carboxylic acids, such as chloroacetic acid, trichloroacetic acid, acetic acid, acrylic acid, benzoic acid, trifluoroacetic acid, citric acid, crotonic acid, formic acid, fumaric acid, maleic acid, malonic acid, gallic acid, itaconic acid, lactic acid, tartaric acid, oxalic acid, phthalic acid and succinic acid, acidic ion exchangers, acidic zeolites, acid-activated fuller's earth and acid-activated carbon black.

The acid catalysts may also themselves be surfactants. Examples include polyoxyalkylene sulfates, phosphates, phosphonates, carboxylates, and the like. In other words, an emulsifier, more particularly a polyoxyalkylene polymer bearing at least one covalently bonded acid group. Other surfactants bearing acid groups are also useful. When such catalysts are used, they may partially or totally replace the surfactants used to emulsify the reactants/products. In this case, they provide a dual function. It is preferable to use surface-active acidic polymerization catalysts, since they permit particularly specific and highly reproducible setting of the oil viscosity.

Useful surface-active, acidic polymerization catalysts for the process of the invention include a large number of sulphonic acids, hydrogensulphates and/or mono--or diesters (and/or mixtures) of phosphoric acid, which are not only water, but also oil-soluble.

Examples of useful sulphonic acids are aliphatically substituted naphthalenesulphonic acids, aliphatically substituted phenylsulphonic acids, aliphatic sulphonic acids, silylalkylsulphonic acids and aliphatically substituted diphenyl ether sulphonic acids. Aliphatic substituents for this purpose contain at least 6 carbon atoms, preferably at least 8 carbon atoms and more preferably at least 10 carbon atoms, and also preferably not more than 18 carbon atoms. Examples of such aliphatic substituents are hexyl, octyl, decyl, dodecyl, cetyl, myricyl, nonenyl, phytyl and penta-decadienyl radicals.

Examples of useful hydrogensulphates are alkyl hydrogensulphates having branched or unbranched alkyl radicals having at least 8 and more particularly 10 to 18 carbon atoms, such as hexyl, octyl, dodecyl, cetyl, stearyl, myricyl, oleyl and octynyl radicals.

Examples of useful esters of phosphoric acid are mono- and/or dialkyl (and/or mixtures) phosphoric esters with organic radicals such as branched or unbranched alkyl radicals having 4-30 carbon atoms, such as butyl, hexyl, 2-ethylhexyl, octyl, isononyl, dodecyl and iso-tridecyl radicals, unsaturated aliphatic radicals such as oleyl radicals, aromatic radicals, such as phenyl, toloyl, xylyl, nonylphenyl, naphthyl, anthracyl, tristyrylphenyl or benzyl radicals. The acid number of useful phosphoric esters is determined by the average value a of the number of organic radicals (where a is 1 or 2) and the molar mass, usually reported by the amount of KOH in mg needed to neutralize 1 g of the phosphoric ester. This acid number is preferably in the range of 10-500, more preferably in the range of 200-400 and more particularly in the range from 250 to 350.

Surface-active, acidic polymerization catalysts may comprise not only an individual compound but also mixtures of two or more different compounds of the types mentioned. Mixtures will generally be used in practice, since these acids are but difficult to obtain pure because of their high molecular weight.

The process according to the invention preferably utilizes the acidic catalysts in amounts of at least 0.1 part by weight, more preferably at least 0.4 part by weight and most preferably at least 0.8 part by weight and at most 50 parts by weight, more preferably at most 40 parts by weight and most preferably at most 30 parts by weight.

The components are generally agitated to prepare an emulsion in the polymerization process. A micro emulsion or macro emulsion may be formed. The reaction mixture may be heated, but it is preferable to avoid the use of additional heat and rely instead on the heat supplied by the mixing device. Mixing devices may range from simple paddle stirrers to high shear mixers such as the rotor/stator mixers available as ULTRA-TURRAX® mixers from IKA, and homogenizers, such as Gaulin homogenizers, etc. The intensive mixing and dispersing can thus take place in rotor-stator stirred devices, colloid mills, high-pressure homogenizers, microchannels, membranes, jets and the like, or via ultrasound. Homogenizing equipment and methods are described for example in Ullmann's Encyclopedia of Industrial Chemistry, CD-ROM edition 2003, Wiley-VCH Verlag, under the headword “Emulsions”.

The manner of mixing the components needed to produce the emulsions according to the invention is not very critical and can be practiced in various orders. Depending on the particular components, however, there may be preferred procedures which should be examined on a case by case basis. In general, the emulsifier, acid catalyst, and a portion of the water are first blended, and the alkanol and hydroxyl-functional organopolysiloxanes are added and emulsified. The alkanol can be blended in the first step with the emulsifier and added catalyst, and is preferably blended with the hydroxyl-functional organopolysiloxane, and this blend is then emulsified into the blend of emulsifier and acid catalyst.

The process of the present invention utilizes the dispersant water in amounts of preferably at least 1% by weight, more preferably at least 5% by weight and most preferably at least 10% by weight and at most 99% by weight, more preferably at most 95% by weight and most preferably at most 90% by weight, based on the total weight of all the ingredients of the emulsion. The product emulsions preferably contain from 25 to 70% polymer, more preferably 30 to 65 weight percent, and most preferably 35 to 60 weight percent.

The product emulsions or dispersions may also contain further substances such as those which have been useful in the past. Examples of water-soluble solids useful as further substances include, for example, inorganic salts such as alkali or alkaline earth metal halides, sulphates, phosphates, hydrogenphosphates, e.g., sodium chloride, potassium sulphate, magnesium bromide, calcium chloride, ammonium chloride, ammonium carbonate, or salts of C₁₋₈ carboxylic acids such as alkali or alkaline earth metal salts, e.g. sodium acetate.

Examples of water-insoluble solids useful as further substances are reinforcing and nonreinforcing fillers. Examples of reinforcing fillers, i.e. fillers having a BET surface area of at least 50 m²/g, are pyrogenously produced silica, precipitated silica or silicon-aluminum mixed oxides having a BET surface area of more than 50 m²/g. The fillers may be in a hydrophobicized state. Examples of nonreinforcing fillers, i.e. fillers having a BET surface area of less than 50 m²/g, are powders of quartz, chalk, cristobalite, diatomaceous earth, calcium silicate, zirconium silicate, montmorillonites, such as bentonites, zeolites including molecular sieves, such as sodium aluminosilicate, metal oxides, such as aluminum oxide or zinc oxide and/or their mixed oxides or titanium dioxide, metal hydroxides, such as aluminum hydroxide, barium sulphate, calcium carbonate, gypsum, silicon nitride, silicon carbide, boron nitride, glass powder, carbon powder and plastics powder and hollow glass and plastics spheres.

The emulsifying step to produce the emulsion used in the process is preferably carried out at temperatures of at least 10° C., more preferably at least 15° C. and at most 80° C., more preferably at most 70° C. The elevated temperature preferably comes about as a result of the introduction of mechanical shearing energy needed for the emulsifying operation. The elevated temperature is not needed to speed a chemical process. The process of the invention is preferably carried out at the pressure of the ambient atmosphere, but can also be carried out at higher or lower pressures.

The average particle size measured in the emulsions by light scattering is preferably at least 0.001 μm, more preferably at least 0.002 μm and at most 100 μm, more preferably at most 50 μm, and most preferably at most 10 μm.

Following the emulsifying step, the polymerization process is preferably carried out at temperatures of at least 1° C., more preferably at least 15° C., and at most 40° C., more preferably at most 35° C. The emulsion is preferably maintained at this temperature for a period, ideally below 24 hours, until the desired degree of polymerization is reached. Occasional or constant further mixing can be advantageous here, and is achieved via any desired technical auxiliary means, such as rapid mechanical agitation or use of ultrasound.

The material may optionally be neutralized to breach the emulsion and determine the degree of fluid polymerization. After the desired time, the emulsion may be neutralized wholly or in part with any desired alkaline agents in order to stop the chain propagation and the concurrently proceeding chain breakage reaction. The alkaline agent is added under agitation until a pH of about 7 is preferably reached. The need to neutralize is determined by the use/application.

Useful alkaline agents for neutralizing, the emulsion include salts such as alkali or alkaline earth metal hydroxides, e.g. sodium hydroxide, potassium hydroxide, lithium hydroxide, alkali or alkaline earth metal carbonates, e.g. potassium carbonate, sodium carbonate, lithium carbonate or ammonium salts, e.g. ammonium hydroxide, or their aqueous solutions, or organic amines or alkanolamines, e.g. triethanolamine (TEA), triethylamine, isopropylamine, or their aqueous solutions.

After the polymerization has ended, the organopolysiloxane can be recovered in a virtually catalyst-free state by breaking the emulsion in any desired manner, for example by adding water-soluble organic solvents, e.g. methanol, ethanol, isopropanol, acetone, or by adding salts, such as sodium chloride, or by removing the water. The added alkanol can be removed following neutralization, for example by stripping, distillation, etc. If necessary, water may be added or removed to produce the desired solids content.

In the examples which follow, all amounts and percentages are by weight, all pressures are 0.10 MPa (abs.) and all temperatures are 20° C., unless otherwise stated in each case.

### EXAMPLES

### Example 1

An emulsifying apparatus, Ultra Turrax T50 with a G45M head, manufactured by IKA Werke is used to combine 21 parts ethoxylated tridecyl alcohol [CAS 78330-21-9], 21 parts dodecylbenzene sulfonic acid [CAS 68584-22-5] and 45 parts reverse osmosis purified water (“RO” water), to which is then added a blend of 313 parts PDM 60, an α,ω-dihydroxy polydimethylsiloxane fluid with a nominal viscosityof 60 mm²/s and 15 parts isopropanol to form a water-in-oil emulsion. To this emulsion is then added an additional 204 parts of water, which upon mixing, inverts to an oil-in-water emulsion.

Triethanolamine, may be added to neutralize the catalyst. A siloxane polymer in a portion of the emulsion is precipitated and washed with acetone. The fluid viscosity is 186,940 mm²/s at 25° C.

Example 2

The procedure of Example 1 was repeated, but with 320 parts PDM 60 and 8 parts isopropanol. The organopolysiloxane polymer had a fluid viscosity of 240,940 mPa·s.

Example 3

The procedure of Example 1 was repeated, but with 320 parts PDM 60 and 15 parts methanol. The organopolysiloxane polymer had a fluid viscosity of 192,240 cps.

### Example 4

The procedure of Example 1 was repeated, but with 320 parts PDM 60 and 8 parts methanol. The organopolysiloxane polymer had a fluid viscosity of 313,290 cps.

### Example 5

The procedure of Example 1 was repeated, but with 320 parts PDM 60 and 2 parts methanol. The organopolysiloxane polymer had a fluid viscosity of 397,430 mPa·s.

### Comparative Example 1

Example 1 was repeated, but no alkanol is added. Fluid viscosity is ca. 479,520 mPa·s.

As can be seen from the Examples and comparative examples, adding alkanol during the polymerization notably lowers the fluid viscosity of the dispersed (oil) phase. Even 0.6 weight percent of methanol (Example 5) lowered fluid viscosity from ca. 480,000 (Comparative Example 1) to ca. 400,000, a decrease of about 17%. Use of higher amounts of alkanol further reduce viscosity, by even more than 50%. With methanol as the alkanol, the relationship between fluid viscosity and weight percent methanol was found to be substantially linear.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A process for the manufacture of an in situ-polymerized organopolysiloxane aqueous emulsion, comprising
a) polymerizing at least one di- or polyhydroxyl functional organopolysiloxane fluid in aqueous emulsion in the presence of an effective emulsifying amount of at least one emulsifier, and in the presence of at least one acid polymerization catalyst;
b) adding at least one alkanol to the aqueous emulsion of step a) prior to completion of polymerization;
c) optionally, neutralizing the acid polymerization catalyst, and
d) recovering an aqueous emulsion of an in situ-polymerized organopolysiloxane,
wherein the neat viscosity of the in situ-polymerized organopolysiloxane is lower than an organopolysiloxane prepared similarly but with no alkanol added.

2. The process of claim 1, wherein the di- or polyhydroxyl-functional organopolysiloxane fluid is an α,ω-dihydroxypolydiorganosiloxane.

3. The process of claim 2, wherein the α,ω-dihydroxypolydiorganosiloxane has the formula 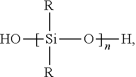
where R is a substituted or unsubstituted hydrocarbon radical having 1 to 40 carbon atoms, wherein when R contains more than 2 carbon atoms, carbon atoms may be interrupted by one or more non-adjacent oxygen atoms, and n is from 2 to 10⁵.

4. The process of claim 3, wherein R each are selected from the group consisting of C₁₋₄ alkyl and phenyl.

5. The process of claim 3, wherein R is methyl.

6. The process of claim 1, wherein at least one alkanol has the formula
R¹—OH
where R¹ is an optionally substituted C₁₋₄₀ aliphatic group or a C₅₋₄₀ cycloaliphatic, or arylaliphatic group.

7. The process of claim 1, wherein the alkanol is a C₁₋₁₄ aliphatic alkanol.

8. The process of claim 1, wherein the acid polymerization catalyst is a polyoxyalkylene polymer bearing a covalently bound acid group.

9. The process of claim 1, wherein the acid polymerization catalyst is an emulsifier bearing at least one covalently bonded acid group.

10. The process of claim 3, wherein the α,ω-dihydroxy polydiorganosiloxane has a viscosity at 25° C. of from 5 to 80,000 mm²/s.

11. The process of claim 1, wherein the alkanol of step b) is added to the di- or polyhydroxyl functional organopolysiloxane prior to emulsifying the di- or polyhydroxyl-functional in water to form an aqueous emulsion.

12. The process of claim 1, wherein in step a), a mixture (a1) of water, emulsifier(s), and acid catalyst(s) is first prepared, and the di- or polyhydroxyl functional organopolysiloxane is then admixed with agitation to form the aqueous emulsion.

13. The process of claim 12, wherein the alkanol is first blended with the di- or polyhydroxyl functional organopolysiloxane prior to emulsifying the di- or polyhydroxyl functional organopolysiloxane in the mixture (a1).

14. The process of claim 1, wherein the acid catalyst is at least partially neutralized.

15. The process of claim 14, wherein the acid catalyst is at least partially neutralized by adding an organic amine, an alkanolamine, or mixture thereof

16. An aqueous emulsion of an in situ-polymerized organopolysiloxane, prepared by the process of claim 1.

17. An aqueous emulsion of an in situ-polymerized organopolysiloxane, prepared by the process of claim 2.

18. An aqueous emulsion of an in situ-polymerized organopolysiloxane, prepared by the process of claim 6.

19. An aqueous emulsion of an in situ-polymerized organopolysiloxane, prepared by the process of claim 8.
